(19) United States
(12) Patent Application Publication
(10) Pub. No.: US 2010/0133859 A1
(43) Pub. Date: Jun. 3, 2010

(54) BUMPER FOR A MOTOR VEHICLE

(75) Inventors: Ulrich Lütke-Bexten, Paderborn (DE); Michael Roll, Bielefeld (DE); Elmar Mollemeier, Paderborn (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Benteler Automobiltechnik GmbH, Paderborn (DE)

(21) Appl. No.: 12/627,493

(22) Filed: Nov. 30, 2009

(30) Foreign Application Priority Data
Dec. 1, 2008 (DE) 10 2008 059 750.3

(51) Int. Cl. B60R 19/02

(52) U.S. Cl. 293/102

(57) ABSTRACT

A bumper for a motor vehicle includes a cross member extending transversely to side rails of a vehicle frame. The cross member has a U-shaped cross section which is defined by a web connected on opposite ends to two legs, respectively, and configured to point in a direction of the motor vehicle. The web has a reinforcement embossment in a central length section of the cross member.

### CROSS-REFERENCES TO RELATED APPLICATIONS

This application claims the priority of German Patent Application, Serial No. 10 2008 059 750.3, filed Dec. 1, 2008, pursuant to 35 U.S.C. 119(a)-(d), the content of which is incorporated herein by reference in its entirety as if fully set forth herein.

### BACKGROUND OF THE INVENTION

The present invention relates, in general, to a bumper for a motor vehicle.

The following discussion of related art is provided to assist the reader in understanding the advantages of the invention, and is not to be construed as an admission that this related art is prior art to this invention.

Bumpers are typically mounted across the front and rear of a motor vehicle to absorb impact energy in the event of a crash so as to prevent damage to the actual support structure of the motor vehicle. A bumper includes normally a cross member which can be fixed through intervention of crash boxes in transverse relation to side rails of the vehicle frame. The cross member assumes hereby the task to transmit the energy caused by an impact into the crash boxes which converts the impact energy into deformation work.

Bumpers must comply with regulations and meet the demands by consumer protection organizations with respect to protection of pedestrians. Moreover, bumpers have to meet classification tests of insurance companies (RCAR, GDV). Also automakers demand bumper configurations that allow optimum space utilization, easy installation, maximum energy absorption, and are lightweight as well as economically viable. In particular the desired reduction in CO₂ emission requires lightweight construction when designing vehicles.

It would therefore be desirable and advantageous to provide an improved bumper for motor vehicles, which obviates prior art shortcomings and is reliable in operation while yet being lightweight and simple in structure with optimal energy absorption.

### SUMMARY OF THE INVENTION

According to one aspect of the present invention, a bumper for a motor vehicle includes a cross member extending transversely to side rails of a vehicle frame, the cross member having a U-shaped cross section defined by a web connected on opposite ends to two legs, respectively, and configured to point in a direction of the motor vehicle, the web having a reinforcement embossment in a central length section of the cross member.

In accordance with the present invention, the web is thus arranged on the inner vehicle-proximal side of the cross member. The open side of the cross member points outwards. The cross member is curved concavely in length dimension. The presence of the reinforcement embossment in the central length section of the cross member imparts the bumper with enhanced moment of resistance and improved strength and stiffness characteristics so that the overall weight of the cross member can be reduced.

According to another advantageous feature of the present invention, the central length section of the cross member terminates on opposite ends in end sections, respectively, and can be defined by a width which is smaller than a width of the end sections. In this way, the weight of the bumper can be further decreased.

According to another advantageous feature of the present invention, the legs in the central length section of the cross member may be defined by a width which is smaller than a width of the legs in the end sections of the cross member. As a result, the central length section is recessed in relation to the end sections.

According to another advantageous feature of the present invention, the reinforcement embossment may be configured to project out in the direction of the motor vehicle. The central length section of the cross member may terminate on opposite ends in the end sections via steadily increasing transition zones. Advantageously, each end section of the cross member may have an end provided with a depression. In other words, the end faces of the cross member may be formed with depressions.

According to another advantageous feature of the present invention, the end sections of the cross member may each have an attachment zone for connection of a crash box, with the attachment zone having a flat support surface which is recessed in relation to the legs of the cross member. In view of the provision of attachment zones with the support surfaces for connection of the crash boxes, impact energy can be deflected into the crash boxes with as little bending moment as possible.

According to another advantageous feature of the present invention, a front plate may be connected to a free end of a leg in transverse relationship to the leg. In this way, energy absorption and overall stress behavior of the cross member can be markedly enhanced.

According to another advantageous feature of the present invention, the legs may be sized of different length. For example, the upper one of the legs may have a length which is greater than a length of the lower one of the legs.

According to another advantageous feature of the present invention, a mounting plate may be provided to close a front side of the cross member. The mounting plate may have a closed configuration. Suitably, the mounting plate has openings, each of which having a border which is bounded by a circumferential collar which projects inwardly in a direction of the cross member.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a top and rear perspective illustration of a cross member of a bumper according to the present invention;

FIG. 2 is a top view of the cross member of FIG. 1;

FIG. 3 is a top and rear perspective illustration of the bumper with the cross member of FIG. 1 and crash boxes being attached to the cross member;

FIG. 4 is a perspective cutaway view of a portion of the bumper of FIG. 3 with added attachment of a mounting plate to close a front side of the cross member;

FIG. 5 is a plan view of the bumper of FIG. 3 from the rear;

FIG. 6 is a cross sectional view of the cross member, taken along the line A-A in FIG. 5;

FIG. 7 is a cross sectional view of the cross member of FIG. 6 with mounting plate;

FIG. 8 is a cross sectional view of the cross member, taken along the line B-B in FIG. 5;

FIG. 9 is a cross sectional view of the cross member of FIG. 8 with mounting plate;

FIG. 10 is a cross sectional view of the cross member, taken along the line C-C in FIG. 5;

FIG. 11 is a cross sectional view of the cross member of FIG. 10 with mounting plate;

FIG. 12 is a cross sectional view of the cross member, taken along the line D-D in FIG. 5; and

FIG. 13 is a cross sectional view of the cross member, taken along the line E-E in FIG. 5.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

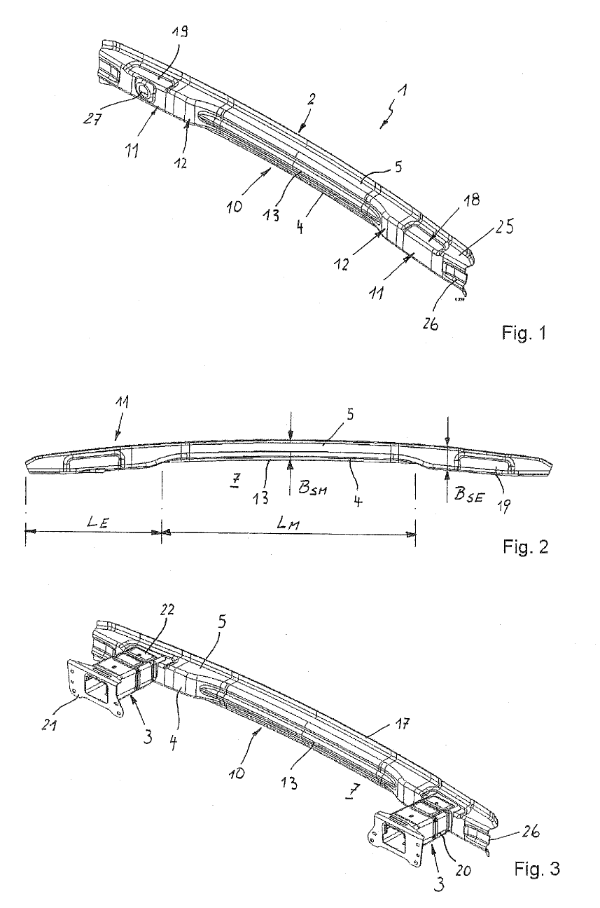

Turning now to the drawing, and in particular to FIG. 1, there is shown a top and rear perspective illustration of a bumper according to the present invention, generally designated by reference numeral 1, for a motor vehicle. The bumper 1 includes a cross member, generally designated by reference numeral 2 and connectable to unillustrated side rails of the motor vehicle via crash boxes 3, shown in greater detail in FIG. 3. The crash boxes 3 in addition to the cross member 2 are provided to absorb energy resulting from an impact or crash by converting the energy into deformation work.

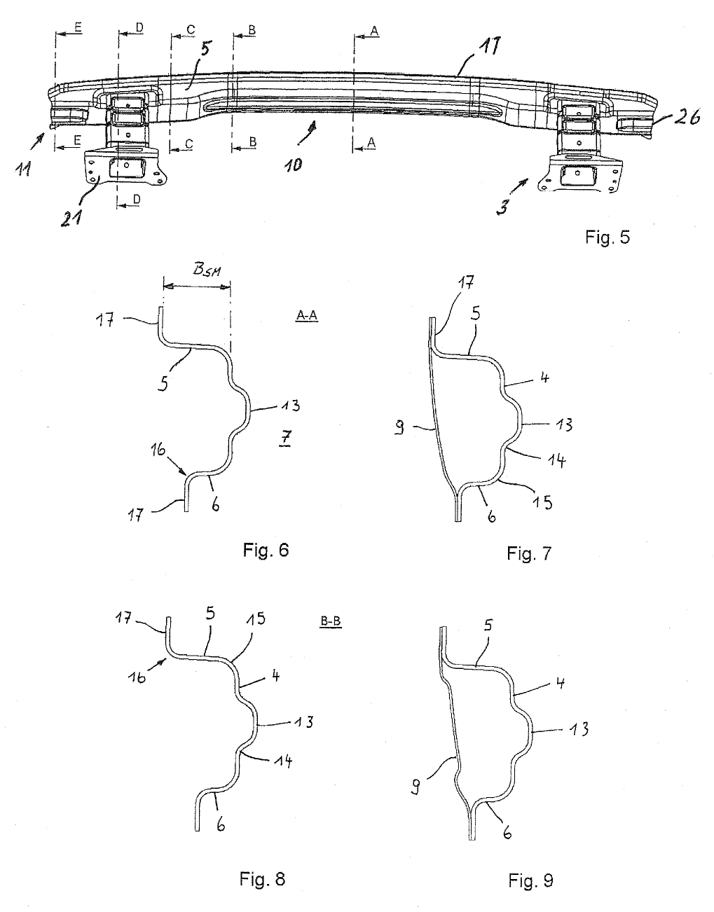

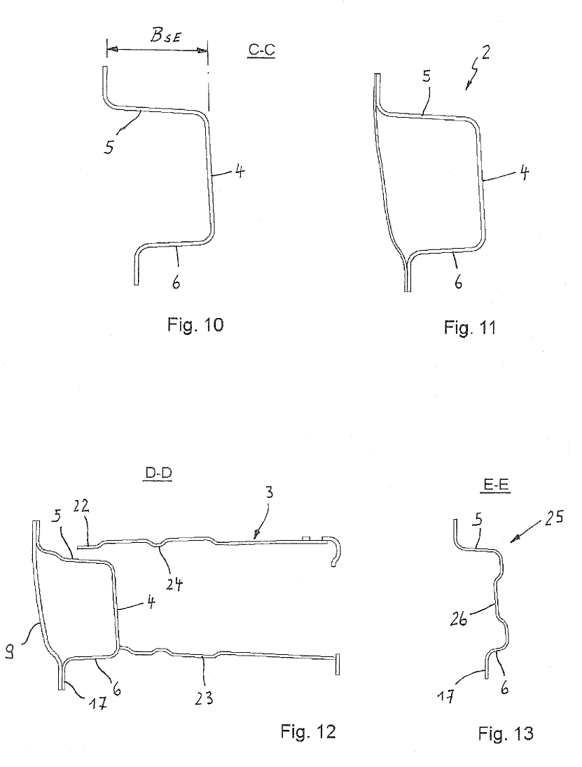

The cross member 2 is made of sheet metal, in particular steel sheet and has a U-shaped cross section with a web 4 terminating on opposite ends in two legs 5, 6, respectively, as best seen in FIGS. 5 to 13. The web 4 of the cross member 2 is placed on the vehicle-proximal side 7 of the cross member 2. The front side of the cross member 2 is open.

The cross member 2 is concavely curved in its length dimension and includes a central length section 10 terminating on opposite ends in end sections 11, respectively. As shown in FIGS. 1-3, the cross member 2 is recessed in the central length section 10 in relation to the end sections 11. As shown in FIG. 2, in the central length section 10 of the cross member 2, the legs 5, 6 have a width B_{SM} which is less than a width B_{SE} of the legs 5, 6 in the end section 11. FIGS. 6 to 13 also show that the legs 5, 6 have different lengths. In particular, the (upper) leg 5 has a length which is longer than the length of the (lower) leg 6. The transition from the central length section 10 to the end sections 11 is hereby gradual and continuous via widening transition zones 12. FIG. 2 also shows that the central length section 10 has a length L_{M} which is about twice as long as the length L_{E} of an end section 11.

The web 4 of the cross member 2 is provided in the central length section 10 with a reinforcement embossment 13 which projects out in a direction of the motor vehicle, as best seen in FIGS. 6 to 9. The reinforcement embossment extends over the entire length L_{M} of the central length section 10 and imparts the cross member 2 in the central length section 10 with a rigid configuration with high moment of resistance and strength and stiffness qualities that are best suited to the stress at hand. The energy absorption of the cross member 2 and thus of the bumper 1 is enhanced. Still, the cross member 2 can be made lightweight, especially as a result of the tapered configuration of the central length section 10.

As further shown by the various cross sectional views of FIGS. 6 to 13, the transitions 14 from the reinforcement embossment 13 to the web 4 as well as the transitions 15 from the web 4 to the legs 5, 6 have a rounded configuration. A front plate 17 is provided at the free end 16 of each leg 5, 6 and extends transversely to the leg 5, 6 towards the outside. The presence of the front plates 17 further assist in the increase of the moment of resistance and enhancement of the strength and stiffness characteristics of the cross member 2.

Referring again to FIG. 1, there is shown that each end section 11 of the cross member 2 has an attachment zone 18 for connection of a crash box 3. The attachment zone 18 has flat support surfaces 19 which are recessed in relation to the legs 5, 6 of the cross member 2. The crash boxes 3 include a generally rectangular hollow deformation profile 20 with a flanged plate 21 on the side of the side rails, as shown in FIG. 3. On the side of the cross member 2, the crash boxes 3 are provided with an upper tongue 22 which extends over the attachment zone 18. FIG. 1 further shows the presence of a through opening 27 in the attachment zone 18 on the left hand side for connection of a tow lug.

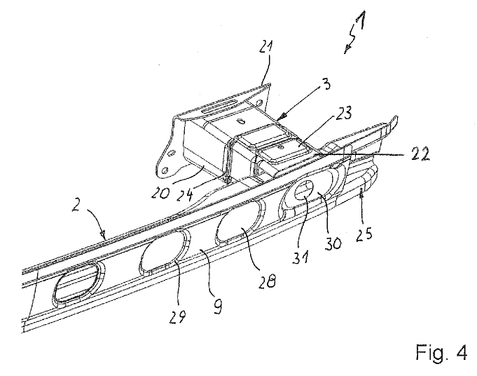

FIG. 4 shows a perspective cutaway view of the bumper 1 with added provision of a mounting plate 9 to close a front side of the cross member 2. The mounting plate 9 is provided with openings 28, each of which being bounded by a circumferential collar 29 which projects inwards in the direction of the cross member 2. In the area of a crash box 3, the mounting plate 9 is drawn-in in the form of a cup to form a bottom 30 in which a through opening 31 is formed for a tow lug. The through opening 31 is much smaller than the openings 28. The mounting plate 9 is sized to extend shy of the end of the cross member, leaving the free ends 25 of the end sections 11 of the cross member 2 exposed.

As further shown in FIG. 4, the crash boxes 3 are provided with outward projections 23 and depressions 24 to influence stiffness and deformation behavior. Also the free ends 25 of the end sections 11 have depressions 26 which project outwards away from the motor vehicle.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A bumper for a motor vehicle, comprising a cross member extending transversely to side rails of a vehicle frame, said cross member having a U-shaped cross section defined by a web connected on opposite ends to two legs, respectively, and configured to point in a direction of the motor vehicle, said web having a reinforcement embossment in a central length section of the cross member.

2. The bumper of claim 1, wherein the central length section of the cross member terminates on opposite ends in end sections, respectively, and is defined by a width which is smaller than a width of the end sections.

3. The bumper of claim 1, wherein the legs in the central length section of the cross member are defined by a width which is smaller than a width of the legs in the end sections of the cross member.

4. The bumper of claim 1, wherein the reinforcement embossment is configured to project out in the direction of the motor vehicle.

5. The bumper of claim 1, wherein the cross member has a front plate connected to a free end of a leg and extending transversely to the leg.

6. The bumper of claim 1, wherein the central length section of the cross member terminates on opposite ends in end sections, each said end section of the cross member having an attachment zone for connection of a crash box, said attachment zone having a recessed flat support surface in relation to the legs of the cross member.

7. The bumper of claim 1, wherein the central length section of the cross member terminates on opposite ends in end sections, each said end section of the cross member having an end provided with a depression.

8. The bumper of claim 1, wherein the central length section of the cross member terminates on opposite ends in end sections via steadily increasing transition zones.

9. The bumper of claim 1, wherein the legs have different lengths.

10. The bumper of claim 1, wherein one of the legs is an upper leg and the other one of the legs is a lower leg, said upper leg having a length which is greater than a length of the lower leg.

11. The bumper of claim 1, further comprising a mounting plate to close a front side of the cross member.

12. The bumper of claim 11, wherein the mounting plate has openings, each said opening having a border which is bounded by a circumferential collar which projects inwardly in a direction of the cross member.
